(19) United States
(12) Patent Application Publication
(10) Pub. No.: US 2008/0122141 A1
(43) Pub. Date: May 29, 2008

(54) Sinterable Powder

(76) Inventors: Bryan Bedal, Santa Clarita, CA (US); Kris Schmidt, Granada Hills, CA (US)

Correspondence Address: SHELDON MAK ROSE & ANDERSON PC, 100 Corson Street, Third Floor, PASADENA, CA, 91103-3842, US

(21) Appl. No.: 11/947,634

(22) Filed: Nov. 29, 2007

Related U.S. Application Data
(60) Provisional application No. 60/872,041, filed on Nov. 29, 2006.

(51) Int. Cl. B41M 5/40

(52) U.S. Cl. 264/405; 428/32.72; 75/252

(57) ABSTRACT

A method of producing an assembled object from a plurality of layers is provided. The method comprises generating a layer of a sintered mass of a sinterable powder on a surface and transferring the layer to an object to be assembled. The sinterable powder may be applied to a surface and at least part of the sinterable powder is fused with a radiant energy source to form a layer of sintered powder. The layer of sintered powder is then transferred to the object to be assembled, the object comprising a plurality of layers of sintered powder fused together. A sinterable powder composition is also provided. The sintered powder comprises at least one thermoplastic polymer and a light absorber. Other materials such as fillers, additives, and flow agents may also be added to the composition. An object comprised of a plurality of layers wherein each layer is a sintered mass of a sinterable powder and each layer is fused at least in part to another layer is provided.

### CROSS-REFERENCE TO RELATED APPLICATION

The present application claims priority of U.S. Provisional Patent Application No. 60/872,041, filed Nov. 29, 2006 titled “Apparatus For Three Dimensional Printing Using Imaged Layers”, the entire contents of which is hereby incorporated herein by reference.

### BACKGROUND

Three dimensional (3D) printers and rapid prototyping (RP) systems, such as those described in U.S. Pat. No. 7,261,442 are known. These printers and systems use an additive, layer-by-layer approach to quickly produce objects and prototype parts from 3D computer-aided design (CAD) tools. The three-dimensional (3D) printer described in U.S. Pat. No. 7,261,442 applies a sinterable polymer powder to a heated roller and then selectively fuses the powder using incident radiation to form an image. The virgin powder is preferably removed using a rotating brush, and the formed image is rolled off onto a stack of previously formed and adhered layers. Sinterable powders are known. Disadvantageously, known sinterable powders do not satisfy the requirements/inputs for a sinterable powder usable in a 3D printer including: adherence to the heated roller; rate of sintering (photospeed); ease of virgin powder removal; resistance to curl distortion; cohesion of imaged layers; thermal stability; and good mechanical properties of the finished 3D object. For example, known sinterable powders suffer from one or more of the following disadvantages: adhering to the heated roller; poor photospeed; difficulty in virgin powder removal; curl distortion; poor cohesion of imaged layers; thermal instability; and poor mechanical properties of the finished 3D object.

Therefore, there is a need for a sinterable powder that: suitably releases from the heated roller; has increased photospeed; ease of virgin powder removal; minimized curl distortion; good cohesion of imaged layers; good thermal stability; and good mechanical properties of the finished 3D object.

### SUMMARY

According to the invention, materials and method for forming three-dimensional (3D) objects using a three-dimensional (3D) printer that satisfy the above-identified needs are provided. The materials and methods described herein may be used in a 3D printer, such as described in U.S. Pat. No. 7,261,542 for fabricating a 3D object or a rapid prototype.

According to one embodiment of the invention, a method of producing an assembled object from a plurality of layers is provided. The method comprises first, generating a layer of a sintered mass of a sinterable powder on a surface, and second, transferring the layer to an object to be assembled. The sintered powder comprises at least one thermoplastic polymer and a light absorber. In one embodiment, the light absorber is admixed into the thermoplastic polymer. In another embodiment, the light absorber is incorporated into the thermoplastic polymer. In yet another embodiment, the light absorber may be present both, as admixed into the thermoplastic polymer and incorporated into the thermoplastic polymer. The sintered mass of the sinterable powder may be generated by directing a radiant energy source onto the sinterable powder and fusing at least part of the sinterable powder.

According to the method of the invention, other materials such as fillers, flow agents, additives, thermals stability agents, and combinations thereof, may be added to the sinterable powder. A preferred material is carbon black. Other materials such as dyes, pigments, and optical brighteners may also be added to the sinterable powder according to the invention.

Also according to the invention, the method further comprises grinding the sinterable powder to modify a flow property.

In a preferred embodiment, a method comprised of producing an assembled object from a plurality of layers is provided. The method comprises first, applying a sinterable powder to a surface. Next, at least part of the sinterable powder is fused with a radiant energy source to form a layer of sintered powder. Then, the layer of sintered powder is transferred to an object to be assembled, where the object to be assembled is a plurality of layers of sintered powder fused together. More preferably, each of the method steps is repeated one or more times to produce the assembled object.

According to another embodiment of the invention, a sinterable powder composition is provided. The sinterable powder according to the invention comprises one or more thermoplastic polymers and incorporates a light absorber, either separately admixed into the thermoplastic polymer; and/or incorporated into the thermoplastic polymer during manufacture. In a preferred embodiment, the light absorber, present in the sinterable powder, contributes to the sinterable powder absorbing at least 20% of incident radiation for a powder coating thickness of between 0.1-0.5 mm for wavelengths between about 0.4 microns and about 6 microns.

According to another embodiment of the invention, the sinterable powder composition is used in a three-dimensional printer, such as the three-dimensional printer described in U.S. Pat. No. 7,261,542.

According to another embodiment of the invention, an object comprised of a plurality of layers is provided. Each layer of the object is a sintered mass of the sinterable powder composition, according to the invention. In the layered object, each layer is fused at least in part to another layer.

The sinterable powder according to the invention is comprised primarily of substantially spherical particles and may be subject to grinding to modify a flow property of the powder. The sinterable powder may also have one or more fillers, one or more additives, and one or more flow agents. The fillers, preferably, are present in the composition in an amount of between about 5 wt % to about 60 wt %. The light absorbers, preferably, are present in the composition in an amount of between about 0.01 wt % to about 1 wt %. The light absorber may be added to the sinterable powder or incorporated into the thermoplastic polymer.

The thermoplastic polymer includes polymers that will perform suitably in the sinterable powder composition described herein, when subject to the conditions of manufacturing a three-dimensional object in a three dimensional printer. Examples of thermoplastic polymers include polyamide, polyethylene, polypropylene, and PEEK. Preferably, the thermoplastic polymer is a polyamide, and more preferably, the polyamide is a polyamide 12. In a preferred embodiment, at least one of the thermoplastic polymers is a polyamide 12, more preferably, the polyamide 12 polymer is selected from the group consisting of Orgasol 2001 UD, Orgasol 2002 ES 6, Vestosint 1111 neutral, Vestosint 1111 black, Vestosint 2155, Vestosint 2157 black, and combinations thereof.

In another preferred embodiment, at least one of the fillers is an Aluminum powder, and/or carbon powder, and/or carbon fibers, and/or glass powder, and/or glass fibers, and at least one of the fillers is a powder comprising particles having aspect ratios between about 1 and about 3 and/or having particle sizes of between about 10 microns and about 150 microns. More preferably, the particle size of the fillers is between about 50 microns and about 90 microns; and/or at least one of the fillers are fibers having aspect ratios between about 3 and about 25, most preferably between about 3 and about 8.

In another preferred embodiment, the sinterable powder freely flows through an orifice of between about 0.5 mm and about 20 mm in diameter, as measured using a Flowdex apparatus, and more preferably, the sinterable powder freely flows through an orifice of between about 4 mm and about 16 mm, as measured using a Flowdex apparatus.

In another preferred embodiment, the flow agent is a powder having a particle size less than about 50 microns, and comprises from between about 1 wt % to about 20 wt % of the sinterable powder, and/or the flow agent is a powder having a particle size of between about 1 micron and about 10 microns. The flow agent may be a ground material, such that the material is non-spherical having rough and jagged edges. In another embodiment, the flow agent is fumed silica, or carbon black, or graphite, and comprises between about 0.01 wt % to about 1.0 wt % of the composition.

In another preferred embodiment, the sinterable powder also has one or more materials selected from the group consisting of dyes, pigments, and optical brighteners. These materials may be present in the composition in an amount of less than about 2 wt % of the sinterable powder. Preferably, the dyes, pigments, and optical brighteners are present in the composition in an amount of between about 0.001 wt % to about 1 wt % of the sinterable powder, and more preferably, the dyes, pigments, and optical brighteners are present in the composition in an amount of between about 0.01 wt % to about 0.1 wt % of the sinterable powder.

In another preferred embodiment, the sinterable powder also contains carbon black. Preferably, the carbon black is present in the composition in an amount of less than 2 wt % of the sinterable powder. More preferably, the carbon back is present in the composition in an amount of between about 0.001 wt % to about 1 wt % of the sinterable powder, and most preferably, the carbon back is present in the composition in an amount of between about 0.01 wt % to about 0.1 wt % of the sinterable powder.

In another preferred embodiment, the sinterable powder also contains one or more additives in an amount of less than about 2 wt % of the sinterable powder.

In another preferred embodiment, the sinterable powder also contains a thermal stability agent. Preferably, the thermal stability agent has a particle sizes less than about 63 microns and/or the thermal stability agent is a phosphite antioxidant. More preferably, the phosphite antioxidant is selected from the group consisting of such tris(2,4-di-tert-butylpheny) phosphite, bis-(2,4-di-tert-butylphenol) pentaerythritol diphosphite, and combinations thereof. Most preferably, the phosphite antioxidant comprises an amount of between about 0.05 wt % to about 3 wt % of the composition, and/or the phosphite antioxidant comprises about 2 wt % of the composition.

### FIGURES

These and other features, aspects and advantages of the present invention will become better understood from the following description, appended claims, and accompanying figures where:

FIG. 1 is a flow chart of a method of producing an assembled object from a plurality of layers.

FIG. 2 is a chart of powder flow rate, as measured using a Flodex apparatus vs. carbon black concentration in a sinterable powder composition;

FIG. 3 is a chart of photospeed vs. carbon black concentration in a sinterable powder composition; and

FIG. 4 is a chart of photospeed vs. glass concentration.

### DESCRIPTION

According to one embodiment of the invention, a sinterable powder composition is provided. The sinterable powder comprises one or more thermoplastic polymer and a light absorber. Other materials such as fillers, additives, and flow agents may also be added to the composition to improve the imaging properties of the powder. The sinterable powder is used in a three-dimensional printer (3DP) to generate an object from multiple fused layers. The sinterable powder according to the invention suitably releases from the heated roller in the three-dimensional printer, has an increased photospeed to speed the build process, easily cleans from a sintered image, has less curl distortion than known sinterable powders, and the imaged layers made from the sinterable powder have good cohesion. In addition, the sinterable powder according to the invention has good thermal stability and the finished 3D object has good mechanical properties. Improved objects formed from a 3D printer, and methods for improving the roller coating process of a 3D printer by employing a sinterable powder according to the invention are also provided.

The sinterable powder according to the present invention has a modified flow behavior in a 3D printer from that of prior known processes. The adhesion of the sinterable powder to the process roller in a 3D printer is also modified from that of prior known processes. The advantages of the present invention may be achieved separately by varying different materials contained in the sinterable powder according to the invention. Various combinations of the above independent advantages of the invention may be obtained by combining techniques for improving the properties of the sinterable powder described herein, as will be understood by those of skill in the art by reference to this disclosure.

As used in this disclosure, the following terms have the following meanings.

The term “filler” means a material that does not undergo a phase change nor undergo any chemical reaction during the printing process.

The term “flow agent” means a material that increases or retards the flow of a sinterable powder from that of a comparable powder without the presence of the flow agent.

The term “light absorber” means a material that, when added to the other formulation components, absorbs at least 20% of incident radiation for any wavelength between about 0.4 microns and about 6.0 microns. The light absorber may be added to the sinterable powder (e.g., dry blended with the sinterable powder), or it may be incorporated into the sinterable powder during manufacturer, such as with a tinted thermoplastic polymer.

The term “measured by visible and infrared spectroscopy” means as measured using the attenuated total reflectance (ATR) method of the Spectrum RX FTIR Spectrometer (PerkinElmer Life And Analytical Sciences, Inc., 940 Winter Street, Waltham, Mass. 02451 USA) for infrared wavelengths, and using the BYK-Gardener Color-Guide Sphere d/8° (BYK-Gardener USA, Rivers Park II, 9104 Guilford Road, Columbia, Md. 21046 USA) for visible wavelengths where >20% light absorption would record an L* value<89 on the CIELab scale.

The term “sinterable powder” means a particulate powder that is capable of being heated to below or up to its melting point to form a solid structure by adherence of at least a portion of the particles in the powder to each other.

The term “sintered powder” means the product (i.e., at least partially fused powder) formed after a sinterable powder has been heated to a temperature below or up to its melting point to adhere at least a portion of the particles in the powder to each other.

As used in this disclosure, the term “comprise” and variations of the term, such as “comprising” and “comprises,” are not intended to exclude other additives, components, numerical values, ranges, or steps.

Unless expressly stated otherwise, all volume percentages (v %) disclosed herein are given in volume percent of the total volume of the composition.

Unless expressly stated otherwise, all weight percentages (wt %) disclosed herein are given in weight percent of the total weight of the composition.

According to one embodiment of the invention, a sinterable powder comprising one or more thermoplastic polymer and light absorber is provided. The light absorber is a material such as a pigment or dye that absorbs incident radiation, including IR radiation. Examples of light absorbers include carbon black, Printex 95, Aniline Black BS 890, Graphtol Blue AN Edition, and Graphtol Red 2BN. Light absorbers may be incorporated into the sinterable powder by dry blending with the sinterable powder composition, or the light absorbers may be incorporated into the thermoplastic polymer during manufacturer. Preferably, the light absorber(s) are present in the powder composition in an amount of between about 0.01 wt % to about 1.0 wt %. Also preferably, the sinterable powder absorbs at least 20% of incident radiation for wavelengths between about 0.4 microns and about 6.0 microns as measured by visible and infrared spectroscopy. The sinterable powder may also have one or more materials selected from the group consisting of one or more fillers, one or more additives, one or more flow agents, and combinations thereof.

According to another embodiment, the invention is a method of producing an assembled object from a plurality of layers. The method comprises generating a layer of a sintered mass of a sinterable powder on a surface, the sintered powder comprising at least one thermoplastic polymer and a light absorber, and transferring the layer to the object to be assembled. Preferably, the method comprises applying a sinterable powder to a surface. Then, at least part of the sinterable powder is fused with a radiant energy source to form a layer of sintered powder. The layer of sintered powder is then transferred to the object to be assembled, the object comprising a plurality of layers of sintered powder fused together. These steps may be repeated until the layered object is completed.

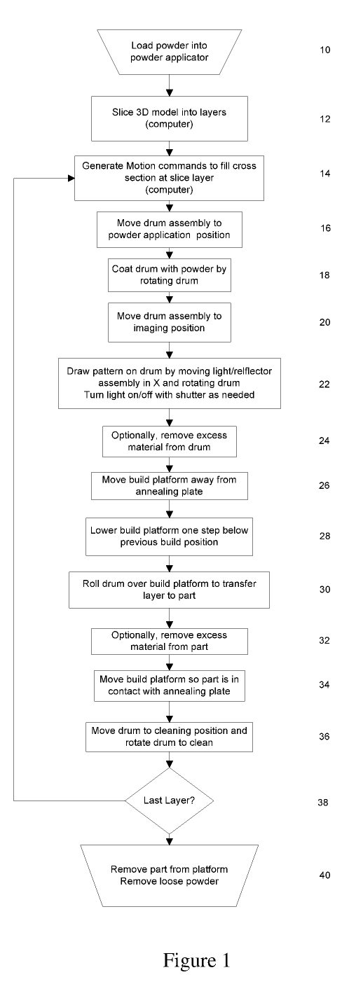

An apparatus which may be used to form the assembled object is the 3D printer described in U.S. Pat. No. 7,261,542, the entirety of which is incorporated herein by reference. A flow chart for the preferred method for producing an assembled object is shown in FIG. 1. As shown in FIG. 1, first a sinterable powder according to the invention is loaded into an applicator (10). Then, a three-dimensional model of the object to be assembled is sliced into layers, in an auxiliary device, such as a computer (12), and a motion command is then generated to a fill cross section at a slice layer (14). A surface assembly (e.g., a drum assembly) is then moved to an application position (16). Next, a sinterable powder according to the invention is applied to the surface (e.g., coat drum assembly with powder by rotating the drum) (18) and the drum assembly is moved into an imaging position (20). A pattern is drawn on the surface of the powder, such as by moving a light/reflector assembly and rotating the drum (22). The portion of the sinterable powder representing a layer is at least partially fused by the energy source (i.e., the light source) being focused on the drum to form the layer of the object. The light may be turned on or off with a shutter as needed. The energy source is preferably a low cost halogen light bulb and an elliptical reflector, which provides the focused heat needed to sinter (fuse) the sinterable powder. However, other energy sources may be used with the invention. Next, in an optional step (24), excess powder (i.e., un-imaged or un-fused powder) may be removed from the surface, such as with a brush. A build platform is then moved away from an annealing plate (26) and the build platform is lowered one step below the previous build position (28). The imaged area (first layer) is transferred onto the object to be assembled, e.g., a part build platform, much like an offset printing process by rolling a drum over the build platform to transfer the layer to the object to be assembled (30). Optionally, excess powder may be removed from the surface (32). The build platform is then moved so the part is in contact with the annealing plate (34). The drum is moved to a cleaning position where the drum is rotated in order to clean (36) excess powder from it. The above steps are repeated until the last layer has been formed (38). Each layer is adhered to the next layer, thereby forming the plurality of layers of the assembled object. Each layer of the assembled object consists of an imaged area (i.e., layer) that represents a cross section of the part and, if needed, a second area is fused with a pattern that is intended to support any part geometries that need support. Preferably, during imaging, the part being assembled is held against a heated annealing plate in order to maintain an optimal temperature and hold the part in its intended shape. A method of producing an assembled object from a plurality of layers is described herein. However, other methods and energy sources may be used with the invention as will be understood by those of skill in the art by reference to this disclosure.

The thermoplastic polymer comprising the sinterable powder includes polymers that will perform suitably in the sinterable powder composition described herein, when subject to the conditions of manufacturing a three-dimensional object in a three dimensional printer. Examples of thermoplastic polymers include polyamide, polyethylene, polypropylene, and PEEK. Preferably, the thermoplastic polymer is a polyamide, and more preferably, the polyamide is a polyamide 12. In a preferred embodiment, at least one of the thermoplastic polymers is a polyamide 12, more preferably, the polyamide 12 polymer is selected from the group consisting of Orgasol 2001 UD, Orgasol 2002 ES 6, Vestosint 1111 neutral, Vestosint 1111 black, Vestosint 2155, Vestosint 2157 black, and combinations thereof. However, other thermoplastic polymers may be used according to the present invention, as will be understood by those of skill in the art by reference to this disclosure.

According to the invention, other materials are added to the powder, which contribute to good process roller coating. The variables that contribute to good process roller coating are powder flow rate, powder particle size, and concentration of inert fillers. The flow rate of the powder within the apparatus must be high enough to insure that the powder moves through the apparatus easily such that the powder is delivered to the heated roller evenly and in sufficient quantity to obtain a uniformly thick coating. However the flow rate of the powder can be too high. In this case the powder slips between the roller and the coating head bar, which meters the correct thickness of powder to the roller, before a sufficient head of powder can be established above the gap between the coating head and the roller.

The flow rate or “flowability” of the powder can be quantified using the commercially available Flodex apparatus (Flodex Apparatus Model 21-101-050 Hanson Research Corp., Chatsworth, Calif.) that permits the observation of powder flow through circular orifices. The Flodex measurement can be expressed as the smallest orifice diameter in millimeters that permits free powder flow from an initially static state. Powders having Flodex measurements greater than 20 mm tend to bridge (mechanical interlock of powder particles forming a stable arch) in hoppers, powder delivery mechanisms, and on the roller during powder application. Powders having Flodex measurements less than 0.5 mm tend to uncontrollably drain out of hopper and roller delivery systems. Accordingly, powders according to the invention having a Flodex measurement between about 0.5 mm and about 20 mm are preferred. Powders having a Flodex measurement between about 4 mm and 16 mm are more preferred.

According to the invention, the flow rate or “flowability” of the powder is modified to produce a powder having good flowability in a 3D printer. Several methods can be employed to modify the flow rate or “flowability” of the powder, including varying the amount of spherical particles in the powder, grinding or milling the powder, varying the average particle size of the powder, and additives. According to one embodiment, a spherical powder is added to the thermoplastic material. Spherical powders have higher flow rates than irregularly shaped powder particles produced through grinding. Consequently, the powder flow rate can be adjusted by varying the ratio of ground powder to spherical powder within the formulation. For example, a formulation containing 60 wt % Orgasol 2002 ES 6 NAT (polyamide 12) and 40 wt % Spheriglass 2530A (spherical glass powder) flows well and coats the roller evenly, while a formulation containing 60 wt % Orgasol 2002 ES 6 NAT and 40 wt % ground glass does not flow well and so does not coat the roller evenly. According to another embodiment, the final formulation can be ground or milled with grinding media (such as an attritor, ball mill, or hammer mill) for increasingly longer periods of time in order to decrease the flow rate of the formulated powder. So for example, the flow rate and roller coating quality of a formulation containing 60 wt % Orgasol 2002 ES 6 NAT, 40 wt % Spheriglass 2530A, 0.035 wt % Raven 420 carbon black can be improved by milling with 0.5 inch diameter steel balls for 30 minutes.

According to another embodiment, the particle distribution of the powder is adjusted or tuned such that the sinterable powder adheres across the entire roller with an even thickness, without scuffing, forming divots or thin patches. Similarly, the powder particle distribution controls the speed at which the powder can be applied to the roller and the ease of virgin powder removal. If the powder particle size is too large, the electrostatic forces and heat transfer rate are insufficient for powder adhesion to the heated roller, resulting in the applied powder falling off the roller and forming divots and/or thin patches, complete failure to form a coating, and/or excessively slow roller coating. If the powder particle size is too small, the electrostatic forces and heat transfer rate are too great, resulting in scuffing of the coating and/or formation of axial ridges and/or radial grooves in the roller powder coating. Additionally, roller coatings formed using excessively small particle size powder are difficult to remove with a brush.

Large diameter particles flow faster than small diameter particles. Consequently, the powder flow rate can be adjusted by varying the ratio of particle sizes. Parts can be built using powders having average particle sizes as great as 150 microns and as small as 10 microns, however spherical powders having average particle sizes between 50 and 90 microns yield the best results and are preferred. The addition of small amounts of powders having average particle sizes less than 20 microns decrease the powder formulation flow rate when present in concentrations of about 1 v % to about 20 v %. Particles in the range of about 2 to about 10 microns on average dramatically decrease the powder formulation flow rate when present in concentrations in the range of about 1 v % to about 10 v %.

For example, Orgasol 2001 UD (5μ_{avg}), Orgasol 2001 EXD (10μ_{avg}), Orgasol 2002 ES 3 NAT (30μ_{avg}) are polyamide 12 powders that all yield poor coatings due the small average particle size of each powder while Orgasol 2002 ES 35 NAT (50μ_{avg}) and Orgasol 2002 ES 6 NAT (60μ_{avg}) both yield good roller coatings. Orgasol products are available from Arkema Inc., 2000 Market Street, Philadelphia, Pa. Similarly, of a formulation containing 60 wt % Orgasol 2002 ES 6 NAT and 40 wt % Spheriglass 2530A (71μ_{avg}) coats the roller well, while a formulation containing 60 wt % Orgasol 2002 ES 6 NAT and 40 wt % Spheriglass 2429A (85μ_{avg}) produces a divoted coating and a formulation containing 60 wt % Orgasol 2002 ES 6 NAT and 40 wt % Spheriglass 2024A (156μ_{avg}) fails to coat. A further example is a formulation composed of 45 wt % polyamide 12 powder, 40 wt % Spheriglass 2530A (71μ_{avg}), 15 wt % aluminum powder (AL-103 available from Atlantic Equipment Engineers, 13 Foster Street, Bergenfield, N.J.). The formulation coats well when the polyamide 12 average particle size is 74 microns, but coats poorly when the polyamide 12 average particle size is 81 microns; and this situation can be corrected by the addition of only 2.5 wt % polyamide 12 having an average particle size of 6 microns.

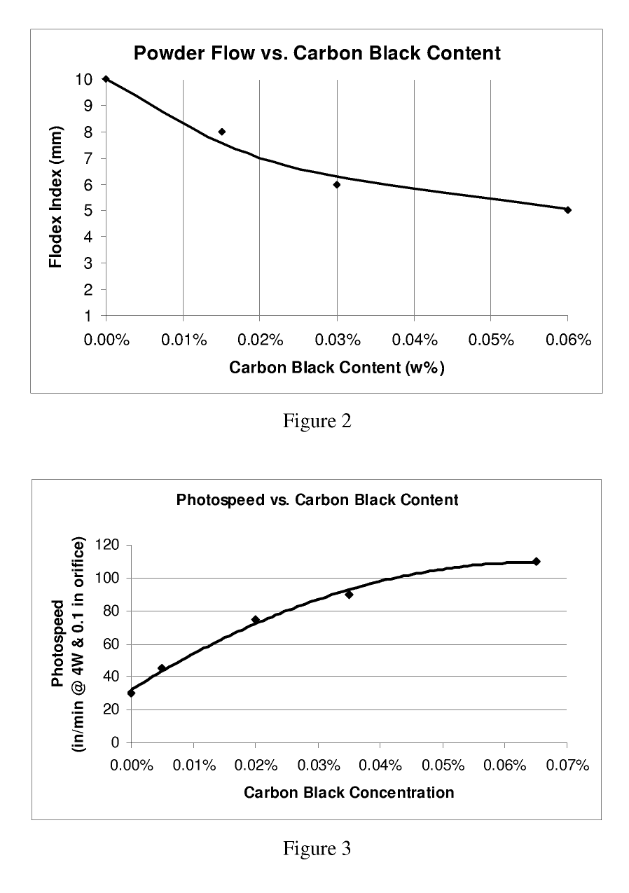

According to another embodiment, the flow rate of the powder is increased by the addition of one or more additives such as fumed silica (such as Cab-O—Sil TS-530 available from E. T. Horn, La Mirada, Calif.) and/or carbon black. These flow additives are most effective when present in concentrations between 0.01 wt % to 1.0 wt % of the formulation. Referring now to FIG. 2, a chart of powder flow rate, measured using the Flodex apparatus, as a function of carbon black concentration for a powder containing 45 wt % polyamide 12 (60 microns) with 55 wt % glass spheres (70 microns) is shown.

According to another embodiment, fillers are employed to minimize curl distortion and to increase photospeed. Excessive filler concentration can, however, inhibit powder adhesion to the roller because, by design, the fillers do not melt or become sticky during processing as do the sinterable thermoplastic components of the formulation. Filler concentration is preferably kept below about 50 v % and more preferably between about 20 v % to about 30 v %.

According to another embodiment, materials are added to adjust the photospeed of the composition. The photospeed, that is the rate at which the sinterable powder absorbs incident radiation, is dramatically affected by the addition of pigments or dyes that preferentially absorb the incident radiation. Carbon black absorbs the broadest range of light wavelengths and dramatically increases the photospeed of pure nylon powder which is naturally white. The addition of 0.04 wt % carbon black, such as Raven 410 or Raven 1000 (available from Colombia Chemical, Marietta, Ga.) to a polyamide 12, such as Orgasol 2002 (available from Arkema) increases the photospeed of the sinterable powder from 30 inches/min to 100 inches/min drawing speed using a 0.1 inch diameter orifice to deliver 4 watts of white light. Referring now to FIG. 3, a chart of photospeed vs. carbon black concentration is shown. Carbon black can be either dry blended with the sinterable powder or it can be incorporated into the sinterable powder during manufacture of the thermoplastic powder. For example, a formulation using a 1:1 ratio of Vestosint 2157 black, which has carbon black incorporated into each particle during manufacture, to Vestosint 2157 natural could be used. Similarly combinations of Vestosint 1111 black with Vestosint 1111 natural could be used, or combinations of black Vestosint materials with other natural tone polyamide 12 will make suitable sinterable powders. Vestosint materials are available from available from Degussa Corp., Parsipanny, N.J. Alternatively, photospeed increases can be obtained using other pigments such as Printex 95 (available from Degussa Corp., Parsipanny, N.J.), Aniline Black BS 890 (available from Degussa Corp., Parsipanny, N.J., Graphtol Blue AN Edition, Graphtol Red 2BN, (available from Clariant Pigments & Additives Division, Gersthofen, Germany). Pigments form agglomerates that must be dispersed within the formulation. Ball milling the pigment with a small aliquot of the powder formulation and then blending this aliquot with the remainder of the batch adequately disperses the pigment. The rate of pigment reagglomeration to deagglomeration may be too high to accomplish dispersion during ball milling. In these cases the addition of about 0.05 wt % to about 0.10 wt % of fumed silica such as Cab-O—Sil TS-530 (available from E. T. Horn, La Mirada, Calif.) will prevent pigment reagglomeration. Some pigments may excessively reduce the powder flow rate; however the addition of about 0.05-0.10 wt % of fumed silica such as Cab-O—Sil TS-530 (available from E. T. Horn, La Mirada, Calif.) can be used to increase the powder flow rate. It will be recognized by those skilled in the art that dyes and similar light absorbing materials will increase the photospeed of the sinterable powder.

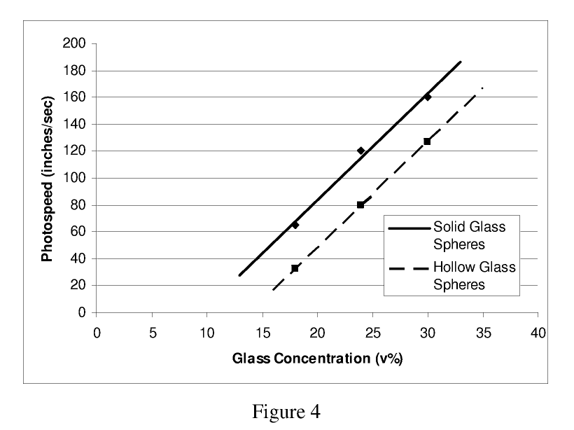

According to another embodiment, photospeed is modified by changing the thermal conductivity of the sinterable powder. For example, the photospeed of a formulation based upon polyamide 12 and carbon black can be increased by more than 5 times with the addition of hollow glass spheres. Referring now to FIG. 4, a chart of photospeed (inches/sec) vs. concentration of hollow glass spheres (wt %) (Q-CEL, available from Potters Industries, Inc. Malvern, Pa.), is shown. Substituting solid glass spheres that have a higher thermal conductivity than the hollow spheres increases the photospeed 1.5 times above that of the hollow glass spheres. Similar increases in photospeed can be observed when aluminum powder is added to the polyamide formulation.

According to another embodiment, the property of powder adhesion to the roller is balanced with removal of unsintered powder (i.e., virgin powder), after the sintering process has occurred in the 3D printer. Flow agents, particle size and filler loading each have an effect on virgin powder removal, operating on the same principles as those described above for process roller coating.

According to another embodiment, one or more fillers are added to the sinterable powder. Curl distortion is often observed when parts are constructed in a layer wise fashion. This occurs when the layer under construction shrinks, due to temperature change or phase change while in contact with the previous layer below, causing the two layers together to curl upward from the edges of the part. This shrinkage and resulting curl distortion of layered object prepared according to the invention may be minimized by adding materials that do not undergo phase change under imaging conditions and/or that have a low coefficient of thermal expansion. Materials having a higher thermal conductivity can also distribute heat faster such that localized heat concentrations are reduced, which reduces distortion in these areas. Accordingly, one or more fillers is added to the sinterable powder of the invention. Examples of such fillers are: metal powders (iron, aluminum, steel, copper, etc.), graphite or carbon black powders, metal oxide powders (alumina, bentonite clay, kaolin clay, talc, etc.), metal sulfate powders (gypsum), metal carbonate powders (calcite), metal hydroxides powders (bauxite), glass powders (silicon dioxide), polymer powders or fibers having a melting point significantly above the melting point of the primary thermoplastic powder (examples of this would be polyamide whiskers or powders combined with polyethylene powder as the primary sinterable powder). Short fibers such as glass or graphite whiskers can also function as inert fillers while simultaneously increasing the mechanical performance of the final composite, since the short fibers resist pulling out of the polymer matrix under stress better than spherical powder particles do under the same conditions.

For example, a sinterable powder composed of a polyamide thermoplastic can have improved part building behavior by adding glass spheres because these materials have a lower coefficient of thermal expansion than polyamide and they do not undergo phase changes (melt) in the same temperature range as polyamide. In the case of metals, glass, graphite and other high modulus materials, these fillers have the additional benefit of increasing the mechanical modulus of the finished composite. Fillers comprising crosslinked rubber and other crosslinked low modulus materials have the additional benefit of increasing the impact resistance of the finished composite. The concentration of inert filler such as glass should be maximized until the amount of filler begins to overwhelm the ability of the polymer powder, such as polyamide, to wet out all of the filler surface causing degradation of the physical properties of the resulting composite. The particle size and shape of the inert filler affects the maximum possible concentration of inert filler. The concentration of inert filler can be higher for more spherically shaped fillers. Similarly, the concentration of inert filler can be higher for larger sized filler particles. For example the optimum concentration of spherical glass having a mean particle size of 70 microns in a sinterable powder based upon polyamide is approximately 25-30 v % (about 40 wt %). The concentration of this type of glass filler can be increased to between about 35-40 v % when the mean particle size is increased to about 150 microns but must be decreased to between about 15-20 v % using when the mean particle size is decreased to about 40 microns. However, materials of large particle size increase the flow rate of the powder and the flow rate can increase to a point where the powder no longer adheres sufficiently to the heated roller. It has been found that the optimum powder flow rates for good roller coating occur with sinterable powder particle sizes in the range of about 50 microns to about 90 microns. Consequently, the optimum inert filler mean particle size is a balance between good roller coating and minimization of curl distortion during part building. Similarly, other inert fillers can function in this regard such as metal powders (iron, aluminum, steel, copper, etc.), graphite powders, metal oxide powders (alumina, bentonite clay, kaolin clay, talc, etc.), metal sulfate powders (gypsum), metal carbonate powders (calcite), metal hydroxides powders (bauxite). Short fibers such as glass or graphite whiskers can also function as inert fillers while simultaneously increasing the mechanical performance of the final composite, since the short fibers resist pulling out of the polymer matrix under stress better than powders particles do under the same conditions. Similarly polymers powders or fibers having a melting point significantly above the melting point of the primary thermoplastic powder can function as inert fillers. Examples of this would be polyamide whiskers or powders combined with polyethylene powder as the primary sinterable powder. Fiber fillers must have a length to diameter ratio (aspect ratio) less than about 20 in order to have adequate flow properties. The aspect ratio of the fibers is optimally between about 2 and about 6.

According to another embodiment, other agents, which enhance the “wetting” ability of the fused powder are provided. The “wetting” ability refers to the ability of the fused powder to wet out the surfaces of the other components of the powder, the roller surface, and the top of the previous part layer. Such wetting agents include low molecular weight polymers and surfactants. The wetting agent generally has a melting point that is within approximately ten degrees of the melting point of the primary polymer powder. The viscosity of molten sintered powder may be decreased with the addition of lower molecular weight polymers or oligomers to the powder formulation. The addition of lower molecular weight polymers or oligomers to a combination of nylon 12 powder and inert fillers such as glass or aluminum powder, for example, can help the imaged layer to better adhere to the top surface of the part under construction. Surfactants in concentrations between about 0.1 wt % and about 1 wt % can also improve the wetting ability of the molten thermoplastic polymer. Suitable surfactants include sodium octyl sulfate and sodium bis(2-ethylhexyl)sulfocuccinate, for example.

The sinterable powder in some embodiments includes a fire retardant to prevent the powder from burning. Fire retardants suitable for use with polyamide such as nylon 12 include melamine cyanurate, melamine phosphate, melamine diphosphate, melamine polyphosphate, or a combination thereof in concentrations between about 2 wt % to about 12 wt % of the sinterable powder.

According to another embodiment of the invention, a thermal stability agent is added to the sinterable powder composition. The thermal stability agent is effective at preventing oxidation of the completed layers in the process of assembling an object in a 3D printer, During the object (i.e., part) building process, for a sinterable powder material composed primarily of polyamide 12, the polyamide powder may oxidize. During the process, the completed layers experience process conditions of temperatures typically above 150° C., and a holding temperature of between about 160-185° C. for many hours. During this time, yellowing of the parts, which is evidence of oxidation of the thermoplastic polymer, may occur. Organophosphites and organophosphonites effectively prevent oxidation under the process conditions; the amount of oxidation observed under the process conditions of part building being inversely proportional to the concentration of organophosphite that is dry blended with polyamide 12 powder. Examples of useful organophosphites include tris(2,4-di-tert-butylpheny) phosphite (Alkanox 240 available from Great Lakes Chemical, West Lafayette, Ind.), bis-(2,4-di-tert-butylphenol) pentaerythritol diphosphite (Ultranox 626 available from Chemtura, Middlebury, Conn.), and tetrakis(2,4-di-tert-butylphenyl)-4,4′-biphenylene diphosphonite (Irgafos P-EPQ available from Ciba Specialty Chemicals, Tarrytown, N.Y.). Organophosphites or organophosphonites have been found to effectively prevent oxidation at concentrations in the range of between about 0.1 wt % to about 10 wt %, preferably between about 0.5 wt % to about 3 wt %, and most preferably between about 1 wt % to about 2 wt % when dry blended with the thermoplastic component(s) of the sinterable powder. Phenolic antioxidants, such as Irganox 1098 and Irganox 1330 (available from Ciba Specialty Chemicals, Tarrytown, N.Y.) were found to either have little positive effect or increase the level of discoloration when polyamide 12 (Orgasol 2002 available from Arkema) was held at or above 160° C. in open air. Combinations of hindered phenolic antioxidants with phosphites or phosphonites were found to be no more effective than using the phosphite or phosphonite alone. The antioxidants (i.e., thermal stability agents) described herein having melting points greater than the process holding temperature (164° C.) are increasingly more effective as the particle size of the antioxidant decreases. For example, about 3 wt % to about 5 wt % of the organophosphate, tris(2,4-di-tert-butylpheny) phosphite (MP=183-186° C.), having particle sizes greater than 50, will prevent oxidation of the layered object when the organophosphate is dry blended with polyamide 12. However, when the particle size of tris(2,4-di-tert-butylpheny) phosphite is reduced to less than 50, through grinding, only about 2 wt % of the organophosphate is required to prevent oxidation of the layered object when the organophosphate is dry blended with polyamide 12. When the melting point of the antioxidant is less than the holding temperature, the particle size does not have the same effect as observed with antioxidants with greater melting points. For example, only about 1 wt % of bis(2,4-di-tert-butylphenol) pentaerythritol diphosphite (MP=160° C.) effectively prevents oxidation when dry blended with polyamide 12, regardless of the phosphite particle size. The phosphite or phosphonite may also be incorporated within the thermoplastic powder during manufacturing such that the antioxidant is evenly distributed within every thermoplastic particle. When tris(2,4-di-tert-butylpheny) phosphite is incorporated this way, only about 0.1 wt % to about 1 wt % is required to prevent oxidation of the polyamides.

The invention may be appreciated in certain aspects with reference to the following examples, offered by way of illustration, not by way of limitation. Materials, reagents and the like to which reference is made in the following examples are obtainable from commercial sources, unless otherwise noted.

### EXAMPLES

### Examples 1-12

Table I below shows formulations of sinterable powders prepared according to the invention.

### General Method for Powder Preparation:

The polymer powders and any fillers, additives, and flow agents, as well as other materials are added to a blender, or other suitable mixing device and mixed until a suitable powder composition is obtained.

Exemplary Method. The sinterable powder composition shown in Example 9 below was prepared as follows:

A PK-3 V-blender (3 cu ft SS “V” Blender available from Patterson-Kelley, East Stroudsburg, Pa.) was charged with 3.45 Kg Vestosint 2155, 1.8 Kg Vestosint 1111 natural, 1.8 Kg Vestosint 1111 black, 1.95 Kg aluminum powder (−325 mesh), and 6.0 Kg Spheriglass 2530A. The composition was blended for 40 minutes and discharged into a 20 liter pail.

TABLE I

| | | | Fillers | | | |
|---|---|---|---|---|---|---|
| | | | Additives | | Thermal | |
| Ex. | Polymer | (wt %) | Flow Agents | (wt %) | Stability Agent | (wt %) |
| 1 | Polyamide 12, | 74% | Aluminum | 16% | — | — |
| | Orgasol 2002 ES 6 | | powder, 325 mesh | | | |
| 2 | Polyamide 12, | 90% | Aluminum | 5% | — | — |
| | Orgasol 2002 ES 6 | | powder, 325 mesh | | | |
| | | | Aluminum | 5% | | |
| | | | powder, 100 mesh | | | |
| 3 | Polyamide 12, | 69.96% | Carbon black, | 0.04% | — | — |
| | Orgasol 2002 ES 6 | | Raven 410 ultra | | | |
| | Polyamide 6, | 30% | | | | |
| | Orgasol 1002 ES 4 | | | | | |
| 4 | Polyamide 12, | 69.96% | Carbon black, | 0.04% | — | — |
| | Vestosint 2155 | | Raven 410 ultra | | | |
| | Polyamide 6, | 30% | | | | |
| | Orgasol 1002 ES 4 | | | | | |
| 5 | Polyamide 12, | 23% | Aluminum | 14% | Irgafos 168 | 2.2% |
| | Vestosint 2155 | | powder, 100 mesh | | | |
| | Polyamide 12, | 23% | Spheriglass 2530A | 37.8% | | |
| | Vestosint 1111 | | Carbon black, | 0.04% | | |
| | | | Printex 95 | | | |
| 6 | Polyamide 12, | 20.8% | Spheriglass 2530A | 40% | Irgafos 168 | 2.2% |
| | Orgasol 2002 ES 6 | | | | | |
| | Polyamide 12, | 23% | | | | |
| | Vestosint 1111 black | | | | | |
| 7 | Polyamide 12, | 23% | Aluminum | 13% | Irgafos 168 | 2.2% |
| | Vestosint 2155 | | powder, 100 mesh | | | |
| | Polyamide 12, | 23% | Spheriglass 2530A | 40% | | |
| | Vestosint 1111 black | | | | | |
| 8 | Polyamide 12, | 23% | Aluminum | 13% | Irgafos 168 | 2.2% |
| | Vestosint 2155 | | powder, 100 mesh | | | |
| | Polyamide 12, | 9.8% | Spheriglass 2530A | 40% | | |
| | Vestosint 1111 | | | | | |
| | natural | | | | | |
| | Polyamide 12, | 12% | | | | |
| | Vestosint 1111 black | | | | | |
| 9 | Polyamide 12, | 23% | Aluminum | 13% | — | — |
| | Vestosint 2155 | | Powder, 325 mesh | | | |
| | Polyamide 12, | 12% | Spheriglass 2530A | 40% | | |
| | Vestosint 1111 | | | | | |
| | natural | | | | | |
| | Polyamide 12, | 12% | | | | |
| | Vestosint 1111 black | | | | | |
| 10 | Polyamide 12, | 23% | Aluminum | 51.8 | Irgafos 168 | 2.2% |
| | Vestosint 2155 | | Powder, 325 mesh | | | |
| | Polyamide 12, | 23% | | | | |
| | Vestosint 1111 black | | | | | |
| 11 | Polyamide 12, | 45.07% | Aluminum | 14% | — | — |
| | Orgasol 2002 ES 6 | | Powder, 100 mesh | | | |
| | | | Spheriglass 2530A | 40% | | |
| | | | Carbon Black, | .03% | | |
| | | | Printex 95 | | | |
| 12 | Polyamide 12, | 35.78 | Aluminum | 14% | Irgafos 168 | 2.2% |
| | Orgasol 2002 ES 6 | | Powder, 100 mesh | | | |
| | (60μ) | | Spheriglass 2530A | 40% | | |
| | Polyamide 12, | 6% | Cab-O-Sil TS-530 | .02% | | |
| | Vestosint 2157 black | | | | | |
| | (57μ) | | | | | |
| | Polyamide 12, | 2% | | | | |
| | Orgasol 2001 UD | | | | | |
| | (5μ) | | | | | |

### Results:

The sinterable powder compositions shown above in Examples 1-12 were prepared according to the General Method and Exemplary Method described above. The powder compositions were tested in 3D printer prototypes and/or laboratory test stands, and a 3D object was assembled. Each of the sinterable powders in Examples 1-12 contained a light absorber, either separately admixed into the sinterable powder, or incorporated into the polymer. Each of the sinterable powders in Examples 1-12 produced a three-dimensional layered object according to the method of the invention, as described herein. The sinterable powders shown in Examples 1-12 showed one or more of the following advantages (1) the sinterable powder suitably released from the heated roller in the three-dimensional printer; (2) the sinterable powder had an increased photospeed to speed the build process compared to similar formulations without light absorbers; (3) the sinterable powder was easily cleaned from the sintered image; (4) the sintered image had less curl distortion than similar formulations where substantially all of the powder undergoes a thermal phase change under the process conditions; and/or (5) the imaged layers made from the sinterable powders had good cohesion. In addition, the sinterable powders showed good thermal stability and the finished 3D objects exhibited good mechanical properties.

### Comparative Examples

| | | | Fillers | | | |
|---|---|---|---|---|---|---|
| | | | Additives | | Thermal | |
| Ex. | Polymer | (wt %) | Flow Agents | (wt %) | Stability Agent | (wt %) |
| A | Polyamide 12, | 100% | | — | — | — |
| | Orgasol 2002 ES 6 | | | | | |
| B | Polyamide 12, | 100% | | — | — | — |
| | Vestosint 2157 | | | | | |
| C | Polyamide 12, | 23% | Aluminum | 14% | | |
| | Vestosint 2155 | | Powder, 325 mesh | | | |
| | natural | | Spheriglass 2530A | 40% | | |
| | Polyamide 12, | 23% | | | | |
| | Vestosint 1111 | | | | | |
| | natural | | | | | |

Examples A, B, and C, each sinterable powder compositions without a light absorber were tested in 3D printer prototypes and/or laboratory test stands, and a 3D object was assembled. The formulas in Examples A and B did not function well in the 3D printing apparatus because the photospeeds of these powders were low, at approximately 30 inches/second, compared with Examples 1-12 that exhibited photospeeds between 100 and 130 inches/second. Similarly, the formula in Example C above exhibited increased photospeed over the formulas in Examples A and B above, due to the addition of aluminum and glass, but the photospeed of the formula shown in Example C was still slow at only 50 inches/second. Additionally, the formulas in Examples A and B produced image roller coatings that had scuff marks and divots because their particle size distributions were not well tailored to the invention.

Although the present invention has been discussed in considerable detail with reference to certain preferred embodiments, other embodiments are possible. Therefore, the scope of the appended claims should not be limited to the description of preferred embodiments contained herein.

What is claimed is:

1. A method of producing an assembled object from a plurality of layers, the method comprising:
a) generating a layer of a sintered mass of a sinterable powder on a surface, the sintered powder comprising at least one thermoplastic polymer and a light absorber; and
b) transferring the layer to an object to be assembled.

2. A method according to claim 1 wherein the sintered mass of the sinterable powder is generated by a radiant energy source onto the sinterable powder and fusing at least part of the sinterable powder.

3. A method according to claim 1 wherein the light absorber is admixed into the thermoplastic polymer.

4. A method according to claim 1 wherein the light absorber is incorporated into the thermoplastic polymer.

5. A method according to claim 1 wherein at least one of the thermoplastic polymers is a polyamide 12.

6. A method according to claim 5 wherein the polyamide 12 polymer is selected from the group consisting of Orgasol 2001 UD, Orgasol 2002 ES 6, Vestosint 1111 neutral, Vestosint 1111 black, Vestosint 2155, Vestosint 2157 black, and combinations thereof.

7. A method according to claim 1 wherein the sinterable powder further comprises one or more fillers.

8. A method according to claim 7 wherein the filler is present in the sinterable powder in an amount of between about 5 wt % to about 60 wt %.

9. A method according to claim 7 wherein at least one of the fillers is an Aluminum powder.

10. A method according to claim 7 wherein at least one of the fillers is selected from the group consisting of carbon powder, carbon fibers, glass powder, glass fibers and combinations thereof.

11. A method according to claim 7 wherein at least one of the fillers is a powder comprising particles having aspect ratios between about 1 and about 3 and having particle sizes of between about 10 microns and about 150 microns.

12. A method according to claim 11 wherein the particle size is between about 50 microns and about 90 microns.

13. A method according to claim 7 wherein at least one of the fillers comprise fibers having aspect ratios between about 3 and about 25.

14. A method according to claim 13 wherein the fibers have aspect ratios between about 3 and about 8.

15. A method according to claim 1 wherein the sinterable powder is comprised primarily of substantially spherical particles.

16. A method according to claim 1 wherein the sinterable powder further comprises a flow agent.

17. A method according to claim 1 wherein the sinterable powder freely flows through an orifice of between about 0.5 mm and about 20 mm in diameter, as measured using a Flowdex apparatus.

18. A method according to claim 17 wherein the sinterable powder freely flows through an orifice of between about 8 mm and about 16 mm as measured using a Flowdex apparatus.

19. A method according to claim 16 wherein the flow agent is a powder having a particle size less than about 50 microns, and comprises from between about 1 wt % to about 20 wt % of the sinterable powder.

20. A method according to claim 16 wherein the flow agent is a powder having a particle size of between about 1 micron and about 10 microns.

21. A method according to claim 16 wherein the flow agent comprises non-spherical particles.

22. A method according to claim 16 wherein the flow agent comprises a ground material having substantially rough and jagged edges.

23. A method according to claim 16 wherein the flow agent is fumed silica, or carbon black, or graphite, and comprises between about 0.01 wt % to about 1.0 wt % of the composition.

24. A method according to claim 1 wherein the method further comprises:
grinding the sinterable powder to modify a flow property.

25. A method according to claim 1 wherein the sinterable powder further comprises one or more materials selected from the group consisting of dyes, pigments, optical brighteners in an amount of less than about 2 wt % of the sinterable powder, and combinations thereof.

26. A method according to claim 25 wherein the dyes, pigments, and optical brighteners comprise an amount of between about 0.001 wt % to about 0.1 wt % of the sinterable powder.

27. A method according to claim 26 wherein the dyes, pigments, and optical brighteners comprise an amount of between about 0.01 wt % to about 0.1 wt % of the sinterable powder.

28. A method according to claim 1 wherein the sinterable powder comprises carbon black.

29. A method according to claim 28 wherein the carbon black comprises an amount of less than 2 wt % of the sinterable powder.

30. A method according to claim 29 wherein the carbon back comprises an amount of between about 0.001 wt % to about 1 wt % of the sinterable powder.

31. A method according to claim 30 wherein the carbon back comprises an amount of between about 0.01 wt % to about 0.1 wt % of the sinterable powder.

32. A method according to claim 1 wherein the sinterable powder further comprises one or more additives.

33. A method according to claim 32 wherein the additives comprise an amount of less than about 2 wt % of the sinterable powder.

34. A method according to claim 1 further comprising a thermal stability agent which effectively prevents oxidation of the layer of the sintered mass of the sinterable powder.

35. A method according to claim 34 wherein the thermal stability agent has a particle sizes less than about 63 microns.

36. A method according to claim 34 wherein the thermal stability agent is a phosphite antioxidant.

37. A method according to claim 36 wherein the phosphite antioxidant is selected from the group consisting of such tris(2,4-di-tert-butylpheny) phosphite, bis-(2,4-di-tert-butylphenol) pentaerythritol diphosphite, and combinations thereof.

38. A method according to claim 36 wherein the phosphite antioxidant comprises an amount of between about 0.05 wt % to about 3 wt % of the composition.

39. A method according to claim 38 wherein the phosphite antioxidant comprises about 2 wt % of the composition.

40. A method of producing an assembled object from a plurality of layers, the method comprising:
a) applying a sinterable powder to a surface, the sinterable powder comprising one or more thermoplastic polymers; and one or more materials selected from the group consisting of one or more fillers, one or more additives, and one or more flow agents;
b) fusing at least part of the sinterable powder with a radiant energy source to form a layer of sintered powder; and
c) transferring the layer of sintered powder to an object to be assembled, the object comprising a plurality of layers of sintered powder fused together.

41. A method according to claim 40 further comprising repeating steps a) through c) one or more times to produce the assemble object.

42. A sinterable powder comprising:
one or more thermoplastic polymers;
one or more fillers, present in the composition in an amount of between about 5 wt % to about 60 wt %;
one or more light absorbers, present in the composition in an amount of between about 0.01 wt % to about 1 wt %.

43. The use of a sinterable powder according to claim 42 in a three-dimensional printer.

44. An object comprising a sintered mass of a sinterable powder according to claim 42.

45. A method of using a sinterable powder according to claim 42 in a three dimensional printer to produce a three dimensional object.

46. A sinterable powder for use in a three-dimensional printer, the sinterable powder comprising:
one or more thermoplastic polymers; and
one or more materials selected from the group consisting of one or more fillers, one or more additives, and one or more flow agents, wherein at least one of the thermoplastic polymers or at least one of the materials comprises a light absorber.

47. A sinterable powder for use in a three-dimensional printer, the sinterable powder comprising:
one or more thermoplastic polymers; and
one or more materials selected from the group consisting of one or more fillers, one or more additives, and one or more flow agents, wherein the sinterable powder absorbs at least 20% of incident radiation for a powder coating thickness of between 0.1-0.5 mm for wavelengths between about 0.4 microns and about 6 microns as measured by visible and infrared spectroscopy.

48. An object comprising:
a plurality of layers, wherein each layer is:
(i) a sintered mass of a sinterable powder, the sinterable powder comprising one or more thermoplastic polymers; and one or more materials selected from the group consisting of one or more fillers, one or more additives, and one or more flow agents, wherein at least one of the thermoplastic polymers or at least one of the materials comprises a light absorber; and
(ii) fused at least in part to another layer.
